(19) United States
(12) Patent Application Publication
(10) Pub. No.: US 2008/0134979 A1
(43) Pub. Date: Jun. 12, 2008

(54) Bird feeder

(75) Inventor: Graham Stuart Crocker, Dorset (GB)

Correspondence Address: NIXON & VANDERHYE, PC, 901 NORTH GLEBE ROAD, 11TH FLOOR, ARLINGTON, VA, 22203, US

(73) Assignee: CROCKER ENTERPRISES LIMITED, Dorset (GB)

(21) Appl. No.: 11/979,943

(22) Filed: Nov. 9, 2007

(30) Foreign Application Priority Data
Nov. 10, 2006 (GB) 0622375.4

(51) Int. Cl. A01K 39/04; A01K 39/02

(52) U.S. Cl. 119/51.5; 119/72

(57) ABSTRACT

A device for delivering liquid and optionally also solid food to birds, said device comprising a container (1) for liquid having a plurality of nipples (4), arranged on a lower surface of said container, a perch (6) supported below the nipples (4), such that birds on the perch (6) can drink liquid from within the container via the nipples and an attractant such as a feeder (14,22) for attracting birds to the device located on the container. One or more bird feeders (9) for solid feed materials may be attached to the sidewalls of the container (1).

The present invention relates to a device for providing drinking water to birds, in particular wild birds.

Many people are keen to encourage garden birds by providing food for them and sometimes also water. Water is generally provided using bird baths and the like. It is difficult to provide a regular supply of clean water in open baths however, and the Royal Society for the Protection of Birds (RSPB) in the UK, has recently reported a rise in diseases caused by parasites and other pathogens such bacteria. It is believed that one of the likely sources of these infections is contaminated bird baths. A particular source of contamination in these baths is regurgitated saliva. Diseases transmitted in this way include a Trichomonas parasite which has been reported in finch species, and to which chaffinches and house sparrows are also susceptible. Other diseases which have been detected in garden birds include Salmonella, Campylobacter and E. coli bacterial infections.

Nipple drinkers have been used in various forms in the livestock industry for providing liquid to birds such as poultry and game birds. Containers for liquid of various forms are provided just above ground level in livestock feeding areas. The containers are substantially sealed but are provided with nipples through which birds standing on the ground can drink. The nipples generally comprise a shaft, arranged to close an opening within the nipple to seal it, and a protruding pin, which contacts the shaft. The shaft may be dislodged from the opening by the pin as a result of the action of a bird pecking at the pin. This allows water from within the container to drip through the opening, in response to the pecking of the bird.

However, such drinkers have never been used in the context of the supply of drinking to wild birds. Furthermore, encouraging wild birds to stay at ground level is undesirable as it makes them more susceptible to ground based predators.

The present invention provides a device for delivering liquid to birds, said device comprising a container for liquid, said container having a suspension element, at least one nipple arranged on a lower surface of said container such that a bird can drink liquid from within the container via the nipple, a perch arranged below the nipple so that a bird on the perch can reach the nipple, said perch being linked to the container by a support, and an attractant for encouraging birds to the device, provided on the container.

The device can be suspended from the suspension element in any suitable environment, such as an outdoor environment, so that safe and clean supply of water may be delivered to birds and in particular wild birds such as garden birds, in a secure situation. In this way, protection from transmission of disease is allowed.

The container may be a substantially sealed container so that the risk of the liquid becoming contaminated during use is minimised. Suitably, the container is provided with a single inlet opening for a liquid delivery tube. The inlet is suitably provided in an upper region of the container. A cap or other closure member may be provided to seal off the inlet once it has been filled with water. The inlet may comprise an outwardly projecting open tube that can interconnect with a conventional garden hose.

Suitably the container has a substantially flat profile, which means that one dimension of the container is significantly less than the others. In particular, the depth of the container is significantly less than the width or the height. For instance the ratio of the depth:height or width of the container is suitably 1:3 or more, preferably 1:10 or more and more preferably 1:20 or more. In particular, the lower surface of the container is elongate so as to allow a more than one nipple to be distributed along the length, for example from 1 to 10 nipples, and suitably about 3 nipples. The elongate lower surface suitably extends entirely across the perch, so that birds standing at any point along the perch may access a nipple.

For instance, typical containers used in the device of the invention will have a depth of from 2-10 cm, and preferably about 3 cm, a height of from 15 cm to 70 m and preferably about 30 cm, and a width of from 10 cm to 50 cm, preferably between 15 to 30 cm.

Thus a particularly preferred shape for the container is a substantially flat triangular, arched or domed shape, but other designs and shapes may be devised.

Such containers are particularly suitable as supports for attractants for birds, which may be conveniently located for example on the side walls, and in particular on planar side walls.

The container is suitably of a moulded plastics material. If convenient however, it may be constructed in modular form and elements connected together subsequently for example using adhesives and/or sealants, to ensure that it is water-tight.

In one embodiment the container is of a transparent material, in particular a transparent plastics material such as natural polyethylene (MDPE) or Perspex™. This increases visibility so as to allow the user to see when fresh water needs to be added. However, preferably, the container is of an opaque material, for example coloured plastics material to minimize the risk of the growth of organisms such as bacteria, algae and fungi within the water inside the container.

The colour of the plastics may be chosen to allow it to blend unobtrusively into the environment, so greens or browns may be selected shades. However, if required, attractive bright colours may be used.

It may be helpful, in particular where the container is of an opaque material to provide a signalling float which is placed inside the container and arranged to project out of an upper surface of the container, for example through an upwardly projecting tube extending out from the container. When the float is visible outside the container, then there is at least some water present within the container. However, where the float disappears inside the tube or the container, this will indicate that the water level has dropped below a predetermined level and the container requires filling. Suitably the float is of a different and preferably highly contrasting colour to that of the container so as to be readily visible.

If required, reinforcing struts or stays may be provided in the container, extending from one wall to the other in particular across the depth of the container. These may prevent bending or other stress effects when the container becomes filled with water.

In order to be suspendable within an open-air environment, the container is suitably provided with a suspension element, such as an eye-hole which can accommodate a hook or the like. The eye hole may be provided in the body of the container but is preferably provided in a lug which extends from the container, suitably in an upwards direction. This allows the container to be freely suspended for example from a convenient branch or twig, or even from a specifically provided support. The suspension element is suitably arranged directly above the plane of the nipples so as to ensure that when suspended from the element, the nipples project downwardly from the lower surface of the container.

Alternatively however, the container may be provided with means such as sidewardly extending lugs with holes therein, to allow a container to be fixed to a garden fence, wall or the like. In this case however, the depth of the container should be sufficient to provide room for the perch and the nipple to be held sufficiently far from the fence, wall or the like to allow a bird to land on it with ease and to drink from the nipple.

The perch is interconnected with the container by way of a support. The support suitably retains the perch in a fixed relation to the lower surface of the container where the nipple is located. Thus for example the support may comprise at least one rigid strut which is attached at one end region to the container so that it extends downwardly therefrom. The strut is also attached to the perch, preferably at the opposing end region thereof. Preferably, two downwardly projecting struts are provided on the container, one of which is fixed to the perch at either end region thereof.

The perch itself is suitably a rigid generally horizontal strut, of a non-perishable material such as plastics. It may not be entirely straight, but may take an irregular form including bends and curves so that it more closely resembles a twig, to encourage birds to land on it.

Suitable attractants for birds may take various forms including for example feeders, audible bird callers or scent or chemical emitters. The inclusion of attractants ensures that the device is fully utilized by the birds. They may be integral with the device or removable so that they may be replaced when finished or readily refilled as necessary.

In a particular embodiment, the attractant comprises at least one bird feeder so as to provide a full nourishment “station” for birds. The combination of drinker and feeders is particularly good for seed-eating birds as their dry diets means they need more water than insectivorous birds, many of whom get most of their water from food.

The bird feeders may conveniently be provided on at least one side wall of the container, and conveniently the larger of the side walls, above the level of the nipples. The feeders suitably comprise holders for seeds or nuts or other forms of bird feed supplies.

The holders are constructed so that birds are able to gain access to the feed material contained therein. The precise structure of the accessible area will depend upon factors such as the nature of the feed and the habits of the target bird population and a variety of such devices are well known in the art.

For example in some cases the holders may comprise at least one area of open weave structure such as mesh or netting, for example wire mesh through which birds can access the contents. The size of the holes in the open weave section will be selected in accordance with the nature of the feed material, so that seeds or grain feed materials may require a relatively small mesh, whilst nuts may be retained behind a slightly larger mesh structure. This is conventional in bird feeders.

Alternatively, the holders may be of solid construction for example of a transparent plastics material, which is provided with one or more openings through which birds may access the contents. Openings are suitably provided with internally projecting shelters, to prevent the contents from pouring out, but rather restrain the seed or like bird feed, so that it only trickles into the base of the opening and birds can access it.

Suitably positioned perches may be attached in the region of the openings to allow birds to perch while eating from the opening.

In a particular preferred embodiment, the or each attractant such as feed holder has a substantially flattened back wall which is, or which engages with, a sidewall of the container. The attractant may project outwardly from the back wall, so as to make it readily visible to the birds. This is particularly appropriate for example in the case of feeders where the food, for example within the transparent plastics holder, or the open weave containing area then projects outwardly, for example to form a substantially hemispherical shape in horizontal cross section.

A closable lid is suitably provided at the top of each holder, to allow it to be filled with bird feed as necessary. The base of the holder may be of a similar open weave structure to that found in the open weave section, or it may have a solid base.

In a particular embodiment, where the container is freely suspendable from an overhead support such as a twig or branch, a feeder is provided on at least the two opposing sidewalls. One may be suitable for holding one type of bird feed material and the other may be suitable for holding a different type of bird feed material so as to encourage the broadest range of birds. Thus for instance, a feeder on one side of the container may hold nuts whilst a feeder on the other side of the container may hold seeds.

Where only one substantial sidewall of the container is freely accessible to birds, more than one feeder may be provided on it.

Preferably each attractant such as holder is detachable from the container. This provides for ease of filling or replacement in the case of disposable attractants. In this case, each holder should clearly have a back wall that is discrete from the container.

In this case, any detachable fastening means may be utilized to retain the attractant such as the feeder onto the container. For instance, resilient arms may be provided which are arranged to engage with suitably positioned holes in the attractant such as the feeder or container respectively. Snap fit type retainers may also be suitably employed to grasp the arms against the feeder or the container. However, various means of detachably retaining the feeder onto the container may be envisaged.

In use, the container is suspended in an open environment, for example in a garden or parkland, or in an aviary or birdcage.

The container is suitably freely suspended for example from the branch of a tree or from a specifically provided support, so that it can move or sway with the prevailing wind. Alternatively, it may be attached to a solid support such as a fence, wall or tree. The device is suitably arranged at a considerable distance above the ground, for example at a height of from 1.5 to 3 metres above the ground.

Birds and in particular wild birds can then be encouraged by the attractant, for example by the provision of food in the feeders where these are included. They may land on the perch where they will have access to the nipple or nipples. When water is present in the container, there will be some leakage out through the nipple or nipples. The greater the amount and therefore the pressure of liquid, the greater the leakage and the larger the drops that form around the nipples. Birds will see these droplets and be encouraged to peck against the nipples, which will then release more water. Birds will learn from this experience and continue to return to drink from the nipples.

Where feeders are also supplied on the device, birds will remain to both feed and drink from it.

The amount of liquid held within the container and feed held within the feeders at any one time will also affect the inertia of the device where this is freely suspended. Preferably, the container will hold sufficient material to ensure that it does not sway or move too much in the breeze or wind, or in response to small stimuli, such as those occurring when birds knock into the device.

Water is suitably introduced into the container through the inlet manually. However, if required, water may be gravity fed through a hosepipe linked to the container from a water supply or reservoir through a required delivery tube into the container. The flow of water is suitably controlled by an automatic dispensing valve, such as that described in British Patent No. 904,991. These valves comprise a fulcrumed arm which cooperates with an anvil surface when displaced, so as to squeeze and thereby close a resilient liquid supply tube or conduit. Displacement of the arm depends upon the weight of an item suspended from the arm, and whether this can overcome a counter-balanced weight. The weight at this will happen can be varied, for example by including a slide member on the shank of the arm, which may be fixable in various positions, for example by a clip mechanism. The arm is spring-loaded to ensure that it is normally liquid supply tube or conduit is normally open.

Where this system is used, the container is suspended from the fulcrumed arm to act as the displacing weight. As water is fed into the container, the weight of the container increases, which increases the downward pressure on the fulcrumed arm, which closes the valve, by compressing the water supply tube which is of a resistant material, thus preventing further flow of water. When the volume of water in the container reduces as it is used, the weight on the fulcrumed arm reduces and the counter-balance arrangement causes the arm to rise, whereupon the valve opens to allow more water to be fed into the container. Particular examples of such valves are sold as Rainbow valves available from Quill Productions (UK) (incorporating the former Rainbow JFN, Ireland). The application of such valves in livestock drinkers is described in U.S. Pat. No. 6,854,420 the content of which is incorporated herein by reference.

The valves where used are preferably adjustable so that the weight of water, which is held within the container at any time, may be varied. For instance, when the device is first used, it may be helpful to increase the volume of water held within the container so that large water droplets, which form around the nipples are readily visible to birds which are stimulated to drink. However, as some birds learn how to access water through the nipples, this stimulus becomes less necessary. Therefore, the valve may be adjusted so that the amount of water within the container at any one time is less, reducing leakage from the nipples.

In a further aspect, the invention provides a method for supplying liquid to birds, in particular wild birds, said method comprising placing liquid in a device as described above, and placing said device in area where birds may gain access to it. Where the device includes bird feeders, they may be filled with suitable feed material such as nuts or seeds, so as to meet a larger proportion of the dietary needs of the birds.

Thus the device of the invention can be flexible in use. It may be adjusted to suit a variety of wildbirds, but also, it may be used in aviaries and the like for caged birds.

The device can be used to administer a medication to caged birds. This may be added to the container so that it is at the required concentration or dosage.

Maintenance of the device is minimal. The sealed nature of the container means that the nipples are unlikely to become clogged by debris. However, should this be the case, or if nipples become defective, these should be readily replaceable by others. In addition, the nipples may be changed to others with different flow rates, to suit the nature of the birds being fed at any particular time. For instance, nipples with relatively high flow rates will be best suited for feeding larger birds, whereas lower flow rate nipples may be used for smaller birds.

The invention will now be particularly described by way of example with reference to the accompanying diagrammatic drawings wherein:

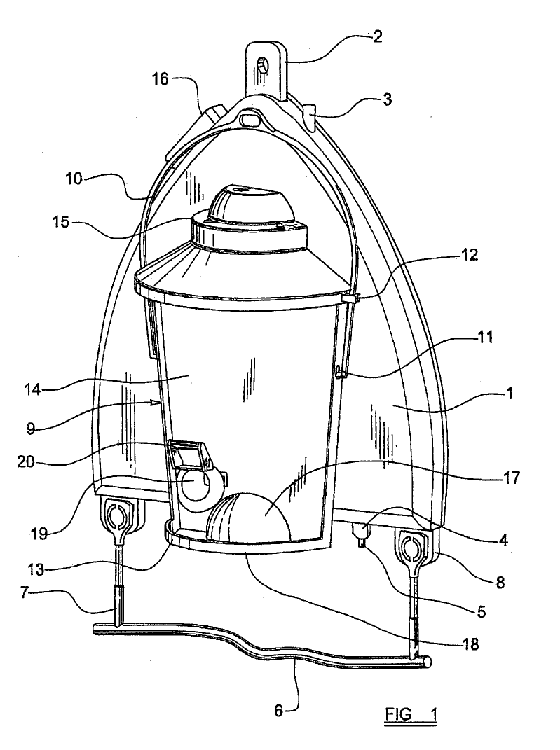

FIG. 1 is a perspective diagram of a device embodying the invention;

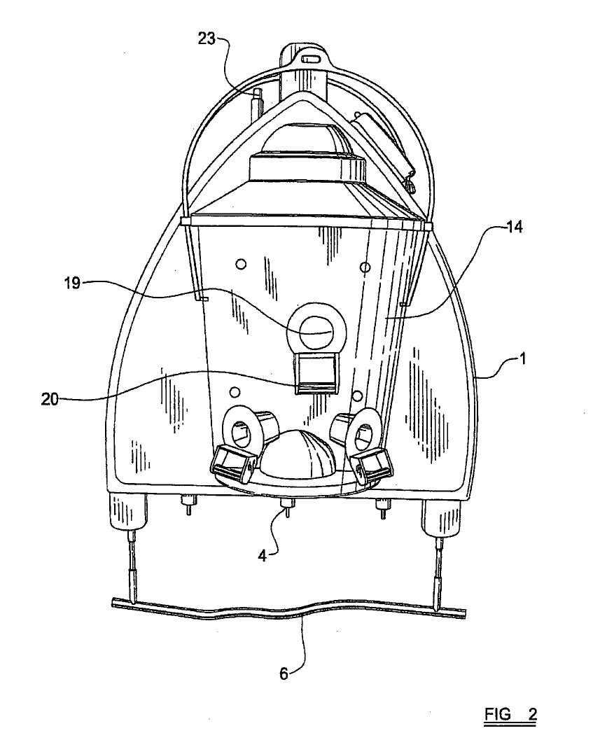

FIG. 2 is a photographic representation of a device embodying the invention;

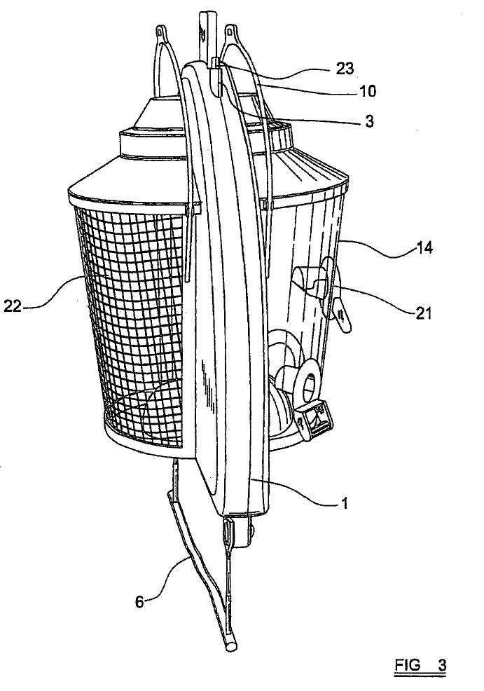

FIG. 3 is a photographic representation of a side view of the device of FIG. 2; and

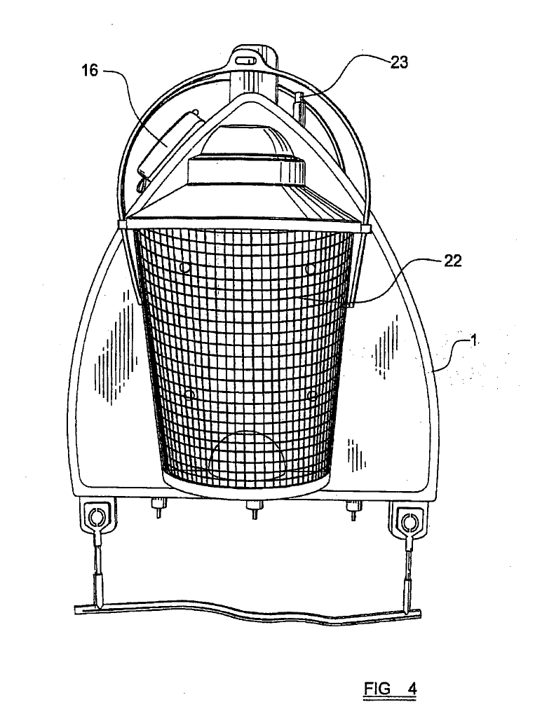

FIG. 4 is a photographic representation of a back view of the device of FIG. 2.

The device of the invention (FIG. 1) comprises an essentially arch-shaped container (1) which is water-tight and which is made of a plastics material which is opaque. The container (1) has a substantially flat profile. A lug (2) is provided at the top of the container (1), to allow it to be suspended from a suitable tree using a cable, string or rope tie.

A small tube (3) which is adapted to hold a signaling float projects out of the container (1) in an upper region thereof.

An inlet opening in the top of the container is closable by means of a cap (16).

In the base of the container (1), are three downwardly projecting nipples (4) (one only shown) which open to the outside of the container (1). The nipples (4) are suitably of the shaft and pin type, with projecting pins (5). When a bird pecks at the pin, the shaft is dislodged, allowing a droplet of water to escape from the nipple (4). In this way, a limited amount of water is dispensed.

An irregular perch (6) is held below the nipples (4) by means of two support struts (7) each of which is bolted to a downwardly projecting lug (8) on the container (1).

An attractant in the form of a bird feeder (9) is detachably fixed to a side wall of the container (1) by means of a pair of resilient arms (10). The ends of the arms (10) are adapted to engage in holes (11) in the sides of the feeder (9). Resilient clasps (12) are also provided on the feeder (9) to further restrain the arms (10).

The bird feeder (9) is fixed so that a back wall abuts closely against the side wall of the container (1). It further comprises a solid base (13). The precise design of the feeder may vary depending upon the nature of the birds being fed or attracted, but generally, the side walls (14) which are convex in relation to the container (1). In the example illustrated in FIGS. 1 and 2, the side walls (14) are of a plastics material with an opening (17) in a base portion through which birds standing on the base (18) can access the contents of the feeder, as well as more or more further openings (19), provided with a individual perch (20) to allow more birds access to the feeder at the same time.

As shown in FIG. 1, the perch (20) is arranged above the opening (19) so that birds may perch and hang downwards to feed as is preferred in many types of bird. An alternative arrangement is illustrated in FIG. 2 where the perch (20) is positioned below the opening (19).

Internally, the openings (17,19) are provided with shelters (21) (FIG. 2) to prevent excessive leakage of feed material into the opening.

On the rear side of the device (FIGS. 3 and 4), a second feeder (22) of a mesh like material such as wire mesh, which is suitable for holding nuts is provided. Birds are able to perch on the mesh structure itself to allow access to the contents.

Each feeder (9, 22) is accessible through a lid (15).

In use, the container (1) is filled with liquid through the tube (3) and feed material is placed in the feeders (9, 22) which is attached to the container (1) by connecting the arms (10) to the holes (11) in the feeder, and snap fitting the clasps (12) over the arms (10).

The device is then suspended above the ground in an area where birds are living or are to be attracted by hanging from the lug (2).

Birds may then land on the perch (6) of the device where they have access to the drink from the nipples (4). They may also feed on the nuts or seeds contained in the feeders (9, 22) by clinging onto the mesh of the side walls of the nut feeder (22) of by utilizing the individual perches (20). A brightly coloured float (23) projecting out of the tube (3) indicates that there is an acceptable level of water within the container (1).

Throughout the operation, the water supply is substantially isolated from the surroundings, thus minimising the risk of contamination from the detritus from the birds and from regurgitated saliva.

If necessary, medication or feed supplements may be added to the water within the container (1).

1. A device for delivering liquid to birds, said device comprising a container for liquid, said container having a suspension element from which it may be suspended, at least one nipple arranged on a lower surface of said container such that a bird can drink liquid from within the container via the nipple, a perch arranged below the nipple so that a bird on the perch can reach the nipple, said perch being linked to the container by a support, and an attractant for encouraging birds to the device, provided on the container.

2. A device according to claim 1 wherein the container may be a substantially sealed container.

3. A device according to claim 1 which has a substantially flat profile.

4. A device according to claim 1 wherein the lower surface of the container is elongate.

5. A device according to claim 1 wherein more than one nipple is provided on the lower surface.

6. A device according to claim 1 wherein the container is a substantially flat triangular, arched or domed shape.

7. A device according to claim 1 wherein the support retains the perch in a fixed relation to the lower surface of the container.

8. A device according to claim 1 wherein the attractant comprises a bird feeder, able to hold a solid bird feed material in a manner which is accessible to birds.

9. A device according to claim 8 wherein the feeder comprises a holder for seeds or nuts.

10. A device according to claim 8 which comprises a first bird feeder capable of holding seeds and a second bird feeder capable of holding nuts.

11. A device according to claim 10 wherein the feeders are arranged on opposing sides walls of the container.

12. A device according to claim 1 wherein the attractant is detachable from the container.

13. A device according to claim 1 which further comprises a signalling float, arranged to project outside the container when at least a predetermined amount of water is contained therein.

14. A device according to claim 1 which further comprises an automatic dispension valve arranged to control the flow of water into the container.

15. A device according to claim 14 wherein the valve is controllable automatically in response to the weight of the container.

16. A method for supplying liquid to birds, said method comprising placing liquid in a device as claimed in claim 1, and placing said device in an environment accessible to birds.

17. A method according to claim 16 wherein the device further comprises a bird feeder and so food also is made available to the birds.
